(19) United States
(12) Patent Application Publication
(10) Pub. No.: US 2020/0301843 A1
(43) Pub. Date: Sep. 24, 2020

(54) MEMORY ACCESS DEVICE, MEMORY SYSTEM, AND INFORMATION PROCESSING SYSTEM

(71) Applicant: SONY SEMICONDUCTOR SOLUTIONS CORPORATION, KANAGAWA (JP)

(72) Inventors: HIDEAKI OKUBO, SAITAMA (JP); KENICHI NAKANISHI, TOKYO (JP); TERUYA KANEDA, KANAGAWA (JP)

(21) Appl. No.: 16/754,680

(22) PCT Filed: Jul. 5, 2018
(86) PCT No.: PCT/JP2018/025468

§ 371 Date: Apr. 8, 2020

(30) Foreign Application Priority Data
Oct. 17, 2017 (JP) 2017-201010

(51) Int. Cl. G06F 12/0884; G06F 12/0868; G06F 12/0871; G06F 12/0873; G06F 11/30; G06F 13/16; G06F 9/4401

(52) U.S. Cl. CPC G06F 12/0884; G06F 12/0868; G06F 12/0871; G06F 9/4411; G06F 11/3037; G06F 13/1668; G06F 12/0873

(57) ABSTRACT

Memory devices having different parallel accessible data sizes and different access speeds are caused to work efficiently as a cache memory. A memory access device accesses first and second memory devices that respectively include a plurality of parallel accessible memories and have different parallel accessible data sizes and different access speeds. The memory access device includes a management information storage unit and an access control unit. The management information storage unit stores management information as associating each corresponding management unit of the first and second memory devices. The access control unit accesses one of the first and second memory devices on the basis of the management information.

### TECHNICAL FIELD

The present technology relates to a memory access device. More particularly, the present technology relates to a memory access device that controls access to a memory in a memory system or an information processing system having a plurality of memories that can be accessed in parallel.

### BACKGROUND ART

Memory systems that improve write performance by combining memories with different access speeds are known. For example, a storage system using two solid state disks (SSDs) having different performances has been proposed (see, for example, Patent Document 1).

### CITATION LIST

### Patent Document

Patent Document 1: Japanese Patent Application Laid-Open No. 2009-199199

### SUMMARY OF THE INVENTION

### Problems to be Solved by the Invention

In the above described conventional technology, in a case where the data to be written to the low-speed SSD is small, proxy writing is performed to the high-speed SSD, and the data is collectively moved to the low-speed SSD according to need. However, since parallel accessible data size and access speed differ depending on the system configuration, there is a possibility that management cannot be efficiently performed in a case where one of the SSDs is used as a cache memory.

The present technology has been developed in view of such a situation, and has an object to efficiently operate memory devices having different parallel accessible data sizes and access speeds as cache memories.

### Solutions to Problems

The present technology has been made to solve the above described problems. The first aspect of the present technology is a memory access device including a management information storage unit that stores management information as associating each corresponding management unit of first and second memory devices respectively, the memory devices including a plurality of parallel accessible memories and having different parallel accessible data sizes and different access speeds, and an access control unit that accesses one of the first and second memory devices on the basis of the management information. With this configuration, there is an effect that the first and second memory devices having different parallel accessible data sizes and different access speeds are accessed on the basis of the management information.

Furthermore, in the first aspect, the second memory device has a faster access speed and a smaller parallel accessible data size compared to the first memory device, and the management information storage unit stores the management information with the parallel accessible data sizes of the first and second memory devices in respective management units. With this configuration, there is an effect that the low-speed first memory device and the high-speed second memory device are accessed on the basis of the management information.

Furthermore, in the first aspect, the management information storage unit may store the management information as associating one predetermined management unit of the first memory device with a plurality of corresponding management units of the second memory device. With this configuration, there is an effect that the first memory device and the second memory device are managed based on the management unit of the first memory device.

Furthermore, in this first aspect, the management information storage unit may store usage condition information that indicates usage condition of an entire of the plurality of management units of the second memory device, corresponding to the one predetermined management unit of the first memory device. With this configuration, there is an effect that the first memory device and the second memory device are collectively managed in the management unit of the first memory device.

Furthermore, in this first aspect, the management information storage unit may store usage condition information that indicates usage condition of each of the plurality of management units of the second memory device, corresponding to the one predetermined management unit of the first memory device. With this configuration, there is an effect that the usage condition is managed separately for each of the plurality of management units of the second memory device.

Furthermore, in this first aspect, the usage condition information may indicate the usage condition of each of the plurality of management units of the second memory device assigned corresponding to the one predetermined management unit of the first memory device in order of assigned addresses. With this configuration, there is an effect that the usage condition is managed according to an order of addresses.

Furthermore, in this first aspect, the usage condition information may indicate an assigned condition of each of the plurality of management units of the second memory device, corresponding to the one predetermined management unit of the first memory device. With this configuration, there is an effect that the assigned condition is managed separately for each of the plurality of management units of the second memory device.

Furthermore, in the first aspect, the management information storage unit may store, as assignment information, whether or not being assigned corresponding to the management unit of the first memory device, for each of the plurality of management units of the second memory device. With this configuration, there is an effect that the assignment is performed for each of the plurality of management units of the second memory device.

Furthermore, in the first aspect, the management information storage unit may store inconsistency information that indicates whether or not there is inconsistency with the first memory device, in any one of the plurality of management units of the second memory device, corresponding to the one predetermined management unit of the first memory device. With this configuration, there is an effect that the consistency of the first memory device and the second memory device is maintained.

Furthermore, in this first aspect, in an idle state, a process for writing, to the corresponding first memory device, data of the second memory device in which the inconsistency information indicates inconsistency with the first memory device may be executed. With this configuration, there is an effect that the consistency of the first memory device and the second memory device is maintained by using a period of the idle state.

Furthermore, in the first aspect, the one predetermined management unit of the first memory device may be assigned to each area where a write command is executed with a maximum throughput of the first memory device. With this configuration, there is an effect that the performance as a memory system is improved to the maximum.

Furthermore, a second aspect of the present technology is a memory system including first and second memory devices that respectively include a plurality of parallel accessible memories and have different parallel accessible data sizes and different access speeds, a management information storage unit that stores management information as associating each corresponding management unit of the first and second memory device, and an access control unit that accesses one of the first and second memory devices on the basis of the management information. With this configuration, there is an effect that the first and second memory devices having different parallel accessible data sizes and different access speeds are included and accessed on the basis of the management information. In this case, the first and second memory devices may be non-volatile memories.

Furthermore, a third aspect of the present technology is an information processing system including first and second memory devices that respectively include a plurality of parallel accessible memories and have different parallel accessible data sizes and different access speeds, a host computer that issues an access command to the first memory device, and an access control unit that includes a management information storage unit and accesses one of the first and second memory devices on the basis of the management information, the management information storage unit storing management information as associating each corresponding management unit of the first and second memory devices. With this configuration, there is an effect that the first and second memory devices having different parallel accessible data sizes and different access speeds are included and the host computer accesses the first and second memory devices on the basis of the management information.

Furthermore, in the third aspect, he access control unit may be a device driver in the host computer. With this configuration, there is an effect that the first and second memory devices are properly used in the host computer.

Furthermore, in the third aspect, the access control unit may be a memory controller in the first and second memory devices. With this configuration, there is an effect that the first and second memory devices are properly used from the host computer with no particular attention.

### Effects of the Invention

According to the present technology, it is possible to achieve an excellent effect that memory devices having different parallel accessible data sizes and different access speeds can be efficiently operated as cache memories. Note that effects described here should not be limited and there may be any one of the effects described in the present disclosure.

### BRIEF DESCRIPTION OF DRAWINGS

FIG. 1 is a diagram illustrating a configuration example of an information processing system according to a first embodiment of the present technology.

FIG. 2 is a diagram illustrating an example of a memory address space according to an embodiment of the present technology.

FIG. 3 is a diagram illustrating a configuration example of a low-speed memory device 300 according to an embodiment of the present technology.

FIG. 4 is a diagram illustrating an example of a parallel access unit and an address space of the low-speed memory device 300 according to an embodiment of the present technology.

FIG. 5 is a diagram illustrating a configuration example of a high-speed memory device 200 according to an embodiment of the present technology.

FIG. 6 is a diagram illustrating a configuration example of a host computer 100 according to an embodiment of the present technology.

FIG. 7 is a diagram illustrating an example of storage contents of a host memory 120 according to the first embodiment of the present technology.

FIG. 8 is a diagram illustrating an example of stored contents of a parallel operation information table 121 according to an embodiment of the present technology.

FIG. 9 is a diagram illustrating an example of storage contents of an entry management information table 122 according to the first embodiment of the present technology.

FIG. 10 is a flowchart illustrating an example of a processing procedure of a write command process of the cache driver 104 according to the first embodiment of the present technology.

FIG. 11 is a flowchart illustrating an example of an entry exporting process of the cache driver 104 according to the first embodiment of the present technology.

FIG. 12 is a flowchart illustrating an example of a processing procedure of a read command process of the cache driver 104 according to the first embodiment of the present technology.

FIG. 13 is a flowchart illustrating an example of a processing procedure of cache replacement process of the cache driver 104 according to the first embodiment of the present technology.

FIG. 14 is a flowchart illustrating an example of a processing procedure of a dirty flag clear process of the cache driver 104 in a modification of the first embodiment of the present technology.

FIG. 15 is a diagram illustrating an example of storage contents of an entry management information table 122 according to a second embodiment of the present technology.

FIG. 16 is a flowchart illustrating an example of a processing procedure of a write command process of the cache driver 104 according to the second embodiment of the present technology.

FIG. 17 is a flowchart illustrating an example of an entry exporting process of the cache driver 104 according to the second embodiment of the present technology.

FIG. 18 is a flowchart illustrating an example of a processing procedure of a read command process of the cache driver 104 according to the second embodiment of the present technology.

FIG. 19 is a flowchart illustrating an example of a processing procedure of a cache addition process of the cache driver 104 according to the first embodiment of the present technology.

FIG. 20 is a diagram illustrating an example of storage contents of a host memory 120 according to a third embodiment of the present technology.

FIG. 21 is a diagram illustrating an example of stored contents of an unassigned address list 124 in the third embodiment of the present technology.

FIG. 22 is a diagram illustrating an example of the stored contents of an entry management information table 122 in the third embodiment of the present technology.

FIG. 23 is a diagram illustrating a specific example of an area assigned condition of the high-speed memory device 200 according to the third embodiment of the present technology.

FIG. 24 is a flowchart illustrating an example of a processing procedure of a write command process of the cache driver 104 according to the third embodiment of the present technology.

FIG. 25 is a flowchart illustrating an example of an entry exporting process of the cache driver 104 according to the third embodiment of the present technology.

FIG. 26 is a flowchart illustrating an example of a processing procedure of a read command process of the cache driver 104 according to the third embodiment of the present technology.

FIG. 27 is a flowchart illustrating an example of a processing procedure of a cache replacement process of the cache driver 104 according to the third embodiment of the present technology.

FIG. 28 is an example of a combination of an offset to be measured and a parallel access unit according to a fourth embodiment of the present technology.

FIG. 29 is a flowchart illustrating an example of a processing procedure of a parallel access unit measurement process of the cache driver 104 according to the fourth embodiment of the present technology.

FIG. 30 is a diagram illustrating a configuration example of an information processing system according to a fifth embodiment of the present technology.

FIG. 31 is a diagram illustrating a configuration example of a memory controller 330 according to the fifth embodiment of the present technology.

### MODE FOR CARRYING OUT THE INVENTION

In the following, a mode for implementing the present technology (hereinafter, referred to as an embodiment) will be described. The description will be given in the following order.

1. First embodiment (Example of management based on entry usage flag)

2. Second embodiment (Example of management based on sector usage status)

3. Third embodiment (Example of management based on assigned condition)

4. Fourth embodiment (Example of performance measurement)

5. Fifth embodiment (Example of management in the memory device)

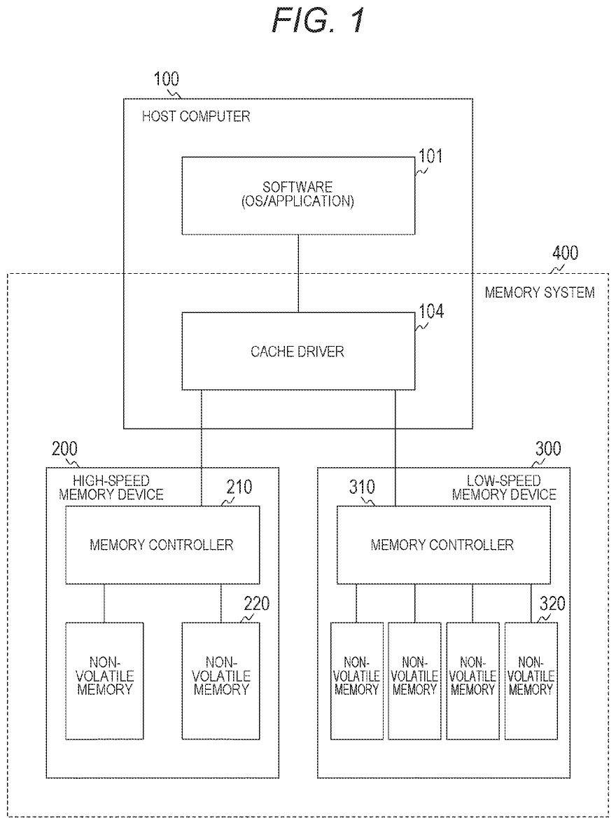

### 1. First Embodiment

[Configuration of Information Processing System] FIG. 1 is a diagram illustrating a configuration example of an information processing system according to a first embodiment of the present technology.

This information processing system includes a host computer 100, a high-speed memory device 200, and a low-speed memory device 300. In this example, the cache driver 104, the high-speed memory device 200, and the low-speed memory device 300 of the host computer 100 constitute a memory system 400.

The host computer 100 issues commands for instructing the low-speed memory device 300 to perform read processing, write processing, and the like of data. The host computer 100 includes a processor that executes processing as the host computer 100. This processor executes an operating system (OS), application software 101, and a cache driver 104.

The software 101 executes a write command and a read command to the cache driver 104 as necessary to write and read data. Memory access from the software 101 is performed targeting the low-speed memory device 300, and the high-speed memory device 200 is used as a cache memory.

The cache driver 104 controls the high-speed memory device 200 and the low-speed memory device 300. The cache driver 104 indicates, to the software 101, an area where data is written and read as a storage space including one continuous address (logical block address: LBA). Note that the cache driver 104 is an example of an access control unit described in the claims.

The low-speed memory device 300 is a memory device that stores an address space viewed from the software 101. In other words, the sector that is the minimum unit that can be specified by the software 101 by the write command and the read command and the capacity to be executed coincide with the sector and capacity of the low-speed memory device 300. The low-speed memory device 300 includes a plurality of non-volatile memories (NVMs) 320 as SSDs, and these are controlled by a memory controller 310. Note that the low-speed memory device 300 is an example of a first memory device described in the claims.

The high-speed memory device 200 is a memory device that can read and write at a higher speed than the low-speed memory device 300, and functions as a cache memory of the low-speed memory device 300. The low-speed memory device 300 and the high-speed memory device 200 each have a plurality of memories that can be accessed in parallel and have different data sizes and access speeds when accessed in parallel. The high-speed memory device 200 has a plurality of non-volatile memories 220 as SSDs, and these are controlled by the memory controller 210. Note that the high-speed memory device 200 is an example of a second memory device described in the claims.

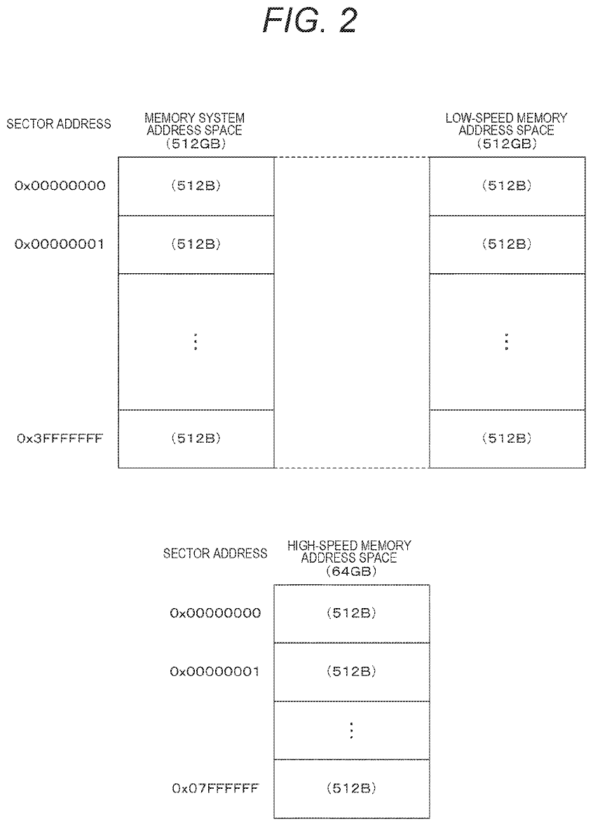

FIG. 2 is a diagram illustrating an example of a memory address space according to an embodiment of the present technology.

In this example, the size and overall capacity of the sector, which is the smallest unit accessible from the software 101 as a memory system, match the sector size and capacity of the low-speed memory device 300. Here, it is assumed that one sector is 512 B (bytes), and the total capacity is 512 GB.

On the other hand, the high-speed memory device 200 that functions as a cache memory has a sector size of 512 B which is the same as the low-speed memory device 300; however, its overall capacity is 64 GB and is smaller than that of the low-speed memory device 300.

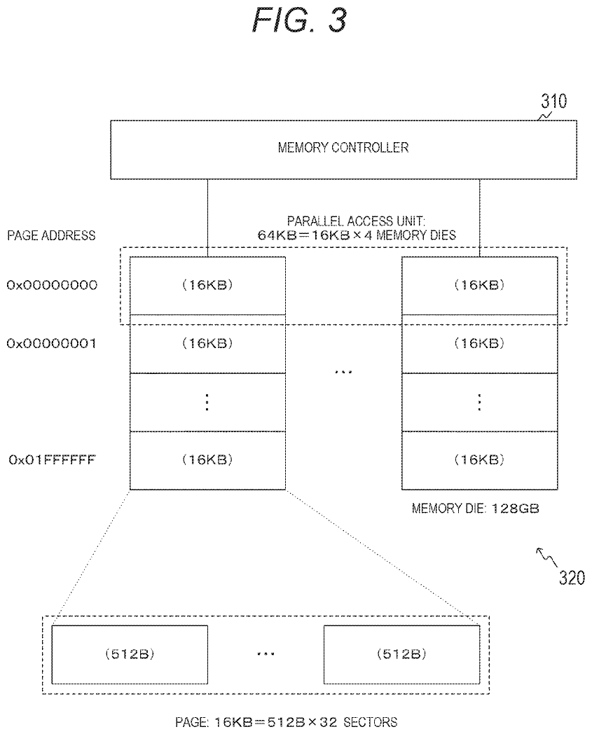

FIG. 3 is a diagram illustrating a configuration example of a low-speed memory device 300 according to an embodiment of the present technology.

The low-speed memory device 300 includes four non-volatile memories (memory dies) 320 each having a capacity of 128 GB, which are controlled by the memory controller 310. The size of a page that is the minimum unit for reading or writing in one non-volatile memory 320 is 16 KB. In other words, 32 sectors of data are recorded on one page. In a case where it is needed to rewrite data of less than 32 sectors, the memory controller 310 performs rewriting by read-modify-write.

The memory controller 310 can perform writing to the four non-volatile memories 320 in at most four parallel writing. At this time, the memory controller 310 executes writing to each page (16 KB) of the four non-volatile memories 320 and execute writing of at most 64 KB.

In a case where the memory controller 310 performs four parallel writing without performing read-modify-write, this results in the maximum throughput of the low-speed memory device 300. In this embodiment, a unit for executing writing with the maximum throughput is referred to as a parallel access unit. In this example, the parallel access unit of the low-speed memory device 300 is 64 KB.

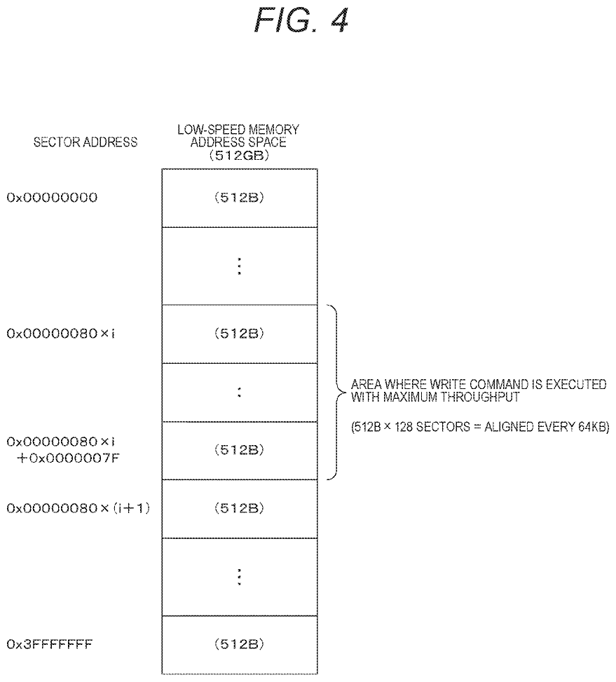

FIG. 4 is a diagram illustrating an example of parallel access units and address spaces of the low-speed memory device 300 according to the embodiment of the present technology.

In order to execute writing with the maximum throughput in the low-speed memory device 300, it is necessary to perform writing to an area aligned every 64 KB which is the parallel access unit. In other words, in a case where execution of a write command is instructed from the memory controller 310 in a multiple of a parallel access unit (64 KB), writing to the low-speed memory device 300 becomes the maximum throughput.

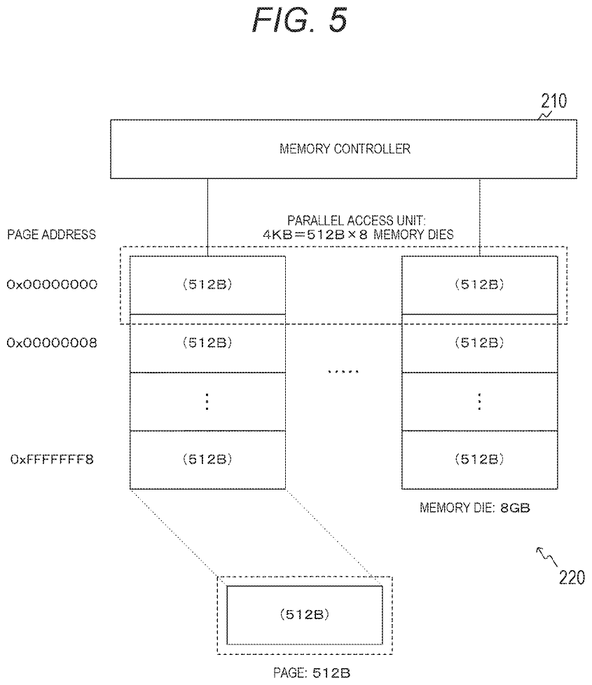

FIG. 5 is a diagram illustrating a configuration example of a high-speed memory device 200 according to an embodiment of the present technology.

The high-speed memory device 200 includes eight non-volatile memories (memory dies) 220 each having a capacity of 8 GB, which are controlled by the memory controller 210. The size of a page that is the minimum unit for reading or writing in one non-volatile memory 220 is 512 B. In other words, one sector of data is recorded on one page.

The memory controller 210 can perform writing to the eight non-volatile memories 220 in at most eight parallel writing. At this time, the memory controller 210 executes writing to each page (512 B) of the eight non-volatile memories 220 and execute writing of at most 4 KB.

In a case where the memory controller 210 performs eight parallel writing without performing read-modify-write, this results in the maximum throughput of the high-speed memory device 200. In this example, the parallel access unit of the high-speed memory device 200 is 4 KB. In other words, in a case where execution of a write command is instructed from the memory controller 210 in a multiple of a parallel access unit (4 KB), writing to the high-speed memory device 200 becomes the maximum throughput.

Note that the parallel access unit is an example of “data size accessed in parallel” recited in the claims. In this embodiment, the parallel access unit is 64 KB for the low-speed memory device 300 and 4 KB for the high-speed memory device 200 as described above.

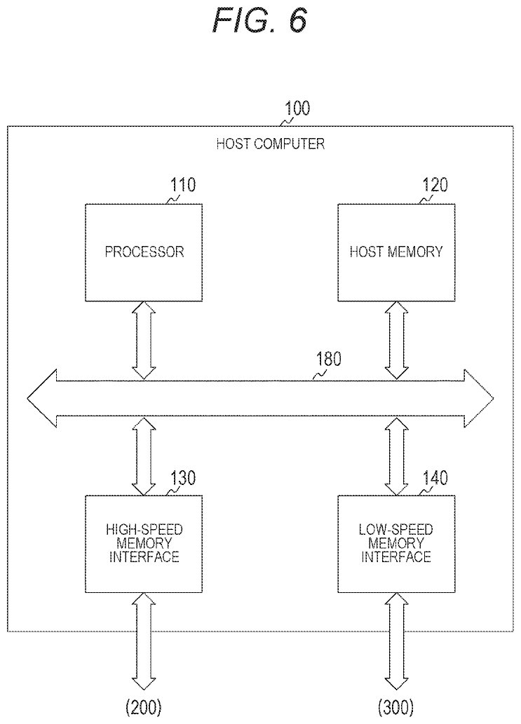

FIG. 6 is a diagram illustrating a configuration example of the host computer 100 according to an embodiment of the present technology.

The host computer 100 includes a processor 110, a host memory 120, a high-speed memory interface 130, and a low-speed memory interface 140, which are connected to each other by a bus 180.

The processor 110 is a processing device that executes processing in the host computer 100. The host memory 120 is a memory that stores data, programs, and the like necessary for execution of processing by the processor 110. For example, the software 101 and the cache driver 104 are executed by the processor 110 after the execution code is expanded in the host memory 120. Furthermore, data used by the software 101 and the cache driver 104 is expanded in the host memory 120.

The high-speed memory interface 130 is an interface for communicating with the high-speed memory device 200. The low-speed memory interface 140 is an interface for communicating with the low-speed memory device 300. The cache driver 104 executes a read command or a write command to each of the high-speed memory device 200 and the low-speed memory device 300 via the high-speed memory interface 130 and the low-speed memory interface 140.

[Table Configuration]

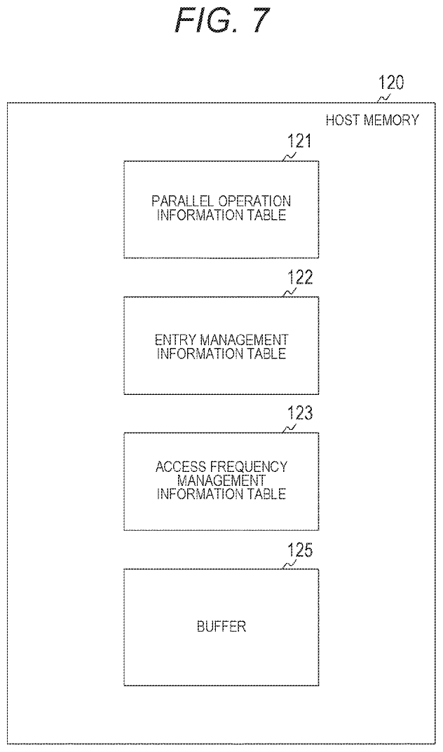

FIG. 7 is a diagram illustrating an example of the storage contents of the host memory 120 according to the first embodiment of the present technology.

The host memory 120 stores a parallel operation information table 121, an entry management information table 122, an access frequency management information table 123, and a buffer 125. The cache driver 104 saves the parallel operation information table 121, the entry management information table 122, and the access frequency management information table 123 in the non-volatile memory of the high-speed memory device 200 or the low-speed memory device 300 (or both) when the host computer 100 is turned off.

The parallel operation information table 121 is a table that holds information for performing parallel operations on the high-speed memory device 200 and the low-speed memory device 300. The entry management information table 122 is a table that holds information for managing each entry in a case where the high-speed memory device 200 is used as a cache memory. The access frequency management information table 123 is a table for managing the access frequency for each entry in a case where the high-speed memory device 200 is used as a cache memory. The cache driver 104 uses the information in the access frequency management information table 123 and manages the access frequency for each entry using, for example, a Least Recently Used (LRU) algorithm. The buffer 125 is a buffer used in a case where data is exchanged between the high-speed memory device 200 and the low-speed memory device 300.

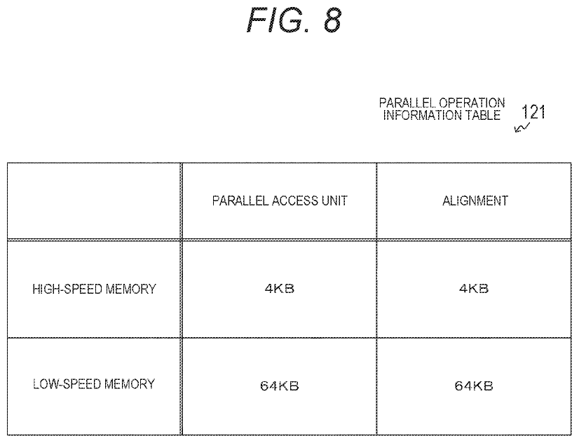

FIG. 8 is a diagram illustrating an example of the stored contents of the parallel operation information table 121 according to the embodiment of the present technology.

The parallel operation information table 121 stores parallel access units and alignments for the high-speed memory device 200 and the low-speed memory device 300. As described above, the parallel access unit is 4 KB for the high-speed memory device 200 and 64 KB for the low-speed memory device 300. The alignment is a unit of area arrangement for maximum writing throughput, and is 4 KB for the high-speed memory device 200 and 64 KB for the low-speed memory device 300 as in the parallel access unit.

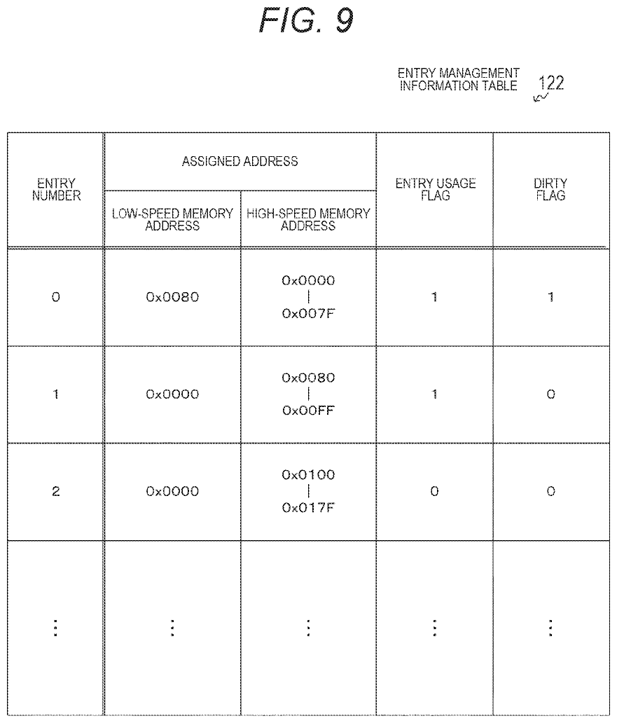

FIG. 9 is a diagram illustrating an example of the contents stored in the entry management information table 122 according to the first embodiment of the present technology.

The entry management information table 122 holds “assigned address”, “entry usage flag”, and “dirty flag” with 64 KB of a parallel access unit for the low-speed memory device 300 as one entry. Note that the entry management information table 122 is an example of a management information storage unit described in the claims.

The “assigned address” indicates a “high-speed memory address” of the high-speed memory device 200 assigned to the “low-speed memory address” of the parallel access unit of the low-speed memory device 300. The “low-speed memory address” corresponds to a logical address of the low-speed memory device 300, and the logical address corresponds to the address of the low-speed memory device 300 on a one-to-one basis. The “high-speed memory address” holds the address of the high-speed memory device 200 where the cached data is recorded.

The “entry usage flag” is a flag indicating whether or not the corresponding entry number is in use. Only in a case where the “entry usage flag” indicates “in use” (“1” for example), the information of the entry is valid. On the other hand, in a case where “unused” (“0” for example) is indicated, the information of the entry is all invalid. Note that the “entry usage flag” is an example of usage condition information described in the claims.

The “dirty flag” is a flag indicating whether or not the data cached by the high-speed memory device 200 has been updated. In a case where the “dirty flag” indicates “clean” (“0” for example), the data of the low-speed memory device 300 of the entry matches the corresponding data of the high-speed memory device 200. On the other hand, in a case where “dirty” (“1” for example) is indicated, the data of the high-speed memory device 200 of the entry has been updated, and there is a possibility that the data of the low-speed memory device 300 of the entry does not much the corresponding data of the high-speed memory device 200. Note that the “dirty flag” is an example of inconsistency information described in the claims.

According to the present embodiment, the low-speed memory device 300 and the high-speed memory device 200 are managed based on the parallel access unit. In other words, the management unit of the low-speed memory device 300 is 64 KB, and the management unit of the high-speed memory device 200 is 4 KB.

In the entry management information table 122, management is performed in units of 64 KB, which is a management unit of the low-speed memory device 300, as one entry, and in units of a management unit for every 4 KB of the high-speed memory device 200.

[Operation]

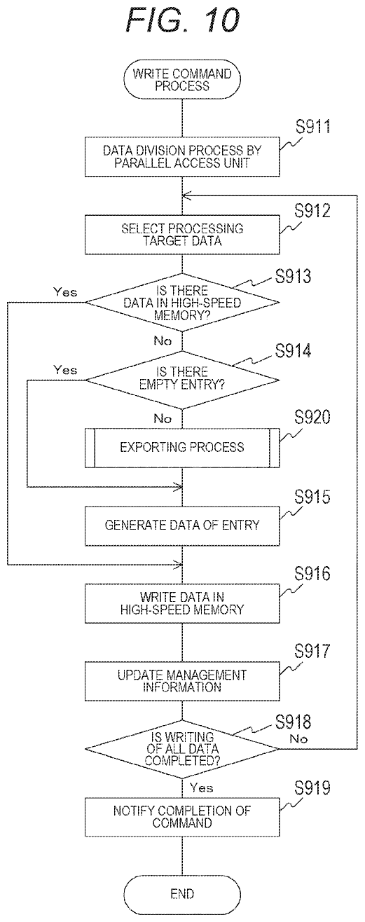

FIG. 10 is a flowchart illustrating an example of a processing procedure of a write command process of the cache driver 104 according to the first embodiment of the present technology. In a case where a write command is received from the software 101, the cache driver 104 divides write data held in the buffer 125 into parallel access units (64 KB) of the low-speed memory device 300 (step S911), and performs the following write process.

The cache driver 104 selects processing target data (step S912) and, in a case where the data is not stored in the high-speed memory device 200 (step S913: No), it is determined whether or not there is an empty entry (step S914). In a case where there is no empty entry in the high-speed memory device 200 (step S914: No), an entry exporting process in the high-speed memory device 200 is executed (step S920). Note that the contents of the entry exporting process (step S920) will be described later.

In a case where there is an empty entry in the high-speed memory device 200 (step S914: Yes), or a case where an empty entry is created by the entry exporting process (step S920), data of the data is generated (step S915). In other words, the data in the low-speed memory device 300 is copied to the high-speed memory device 200.

In a case where the processing target data is stored in the high-speed memory device 200 (step S913: Yes), or a case where the entry data is generated (step S915), the data is written to the entry in the high-speed memory device 200. (Step S916). Then, related to this writing, the entry management information table 122 is updated (step S917).

The processes after step S912 is repeated until all pieces of the data divided for each parallel access unit are written (step S918: No). In a case where the writing of all pieces of data is completed (step S918: Yes), the cache driver 104 notifies the software 101 of completion of the write command (step S919).

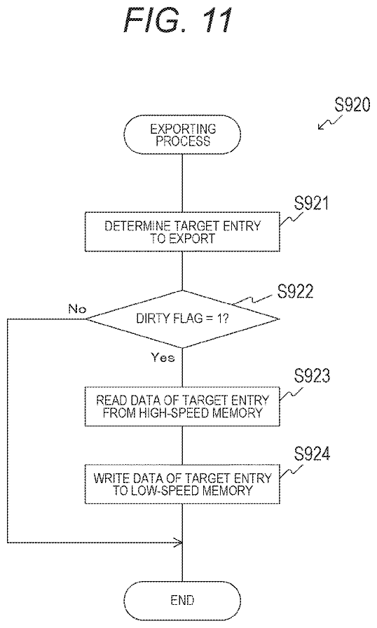

FIG. 11 is a flowchart illustrating an example of a processing procedure of the entry exporting process (step S920) of the cache driver 104 according to the first embodiment of the present technology.

The cache driver 104 refers to the access frequency management information table 123, and determines an entry in the high-speed memory device 200 to be exported based on the LRU algorithm, for example (step S921).

In a case where the “dirty flag” of the entry to be exported indicates “dirty” (step S922: Yes), the data of the entry is read from the high-speed memory device 200 (step S923) and written to the low-speed memory device 300 (step S924). As a result, the data in the low-speed memory device 300 is updated. On the other hand, in a case where the “dirty flag” of the entry to be exported indicates “clean” (step S922: No), since the data of the low-speed memory device 300 of the entry matches the high-speed memory device 200, there is no need to write back to the low-speed memory device 300.

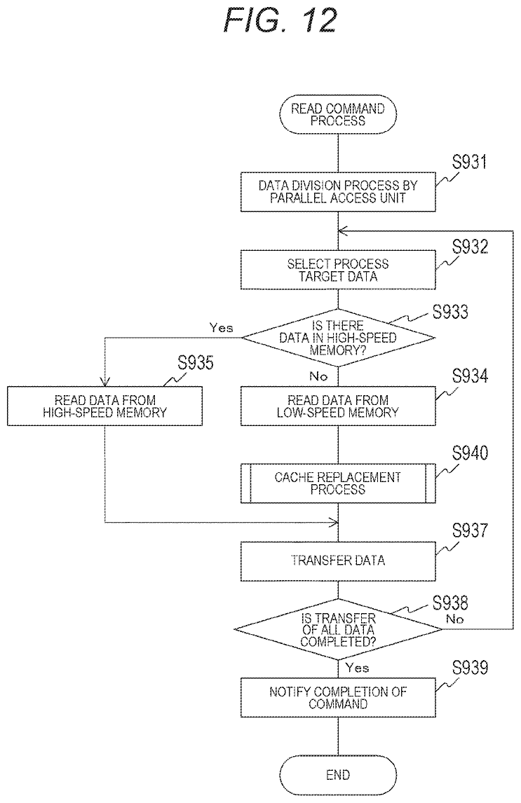

FIG. 12 is a flowchart illustrating an example of a processing procedure of a read command process of the cache driver 104 according to the first embodiment of the present technology. The cache driver 104 divides each low-speed memory device 300 for each parallel access unit (64 KB) (step S931), and performs the following read process.

The cache driver 104 selects processing target data (step S932) and, in a case where the data is stored in the high-speed memory device 200 (step S933: Yes), reads the data from the high-speed memory device 200 (step S935). This is the case of a so-called cache hit.

On the other hand, in a case where the processing target data is not stored in the high-speed memory device 200 (step S933: No), the data is read from the low-speed memory device 300 (step S934). This is the case of a so-called cache miss hit. Then, a cache replacement process is performed (step S940). The contents of this cache replacement process (step S940) will be described later.

In a case where reading from the high-speed memory device 200 or the low-speed memory device 300 is performed, the cache driver 104 transfers the read data to the buffer 125 (step S937).

The processes after step S932 is repeated until all pieces of the data divided for each parallel access unit are read (step S938: No). In a case where the writing of the all pieces of data is completed (step S938: Yes), the cache driver 104 notifies the software 101 of the completion of the read command (step S939).

Note that the cache replacement process may be performed after the read command process is finished. In that case, it is conceivable that the data read from the low-speed memory device 300 is temporarily held in the buffer 125, the cache replacement process is performed, and the data is discarded after the completion. By performing the cache replacement process after the read command process is completed, the number of processes performed during the read command process can be reduced, and the software 101 can receive a read command completion response early.

Here, it has been assumed that the high-speed memory device 200 is used as a read/write cache memory; however, in a case where the high-speed memory device 200 is used as a write cache, the cache replacement process in the read command process is not needed.

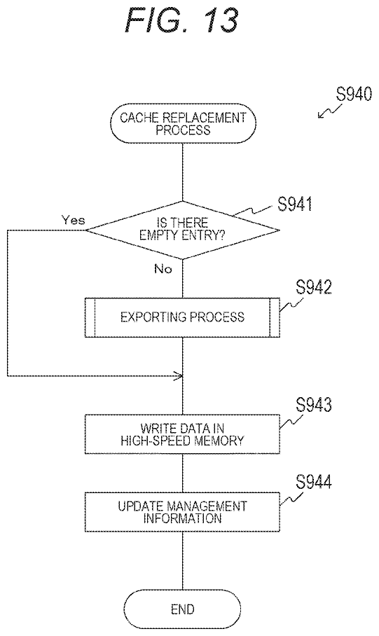

FIG. 13 is a flowchart illustrating an example of a processing procedure of the cache replacement process (step S940) of the cache driver 104 according to the first embodiment of the present technology.

The cache driver 104 determines whether or not there is an empty entry in the high-speed memory device 200 (step S941). In a case where there is no empty entry in the high-speed memory device 200 (step S941: No), an entry exporting process of the high-speed memory device 200 is executed (step S942). Note that the contents of the entry exporting process (step S942) are similar to those of the entry exporting process (step S920) described above, and a detailed description thereof will be omitted.

In a case where there is an empty entry in the high-speed memory device 200 (step S941: Yes), or a case where there is an empty space created by the entry exporting process (step S942), the data in the low-speed memory device 300 is written in the high-speed memory device 200 (step S943). Furthermore, the entry management information table 122 is updated (step S944).

As described above, according to the first embodiment of the present technology, since the high-speed memory device 200 is managed for each area aligned in parallel access units of the low-speed memory device 300, the corresponding high-speed memory device 200 can be efficiently operated as a cache memory.

### Modification Examples

According to the first embodiment described above, the dirty flag is cleared in the entry exporting process (step S922); however, this process can be performed in advance. In other words, the cache driver 104 may perform a dirty flag clear process in an idle state in which no command is received from the software 101. By executing the clear process in advance, in a case where the exporting process occurs during the execution of a write command, the dirty flag is “clean” and the process time is reduced because the process is reduced.

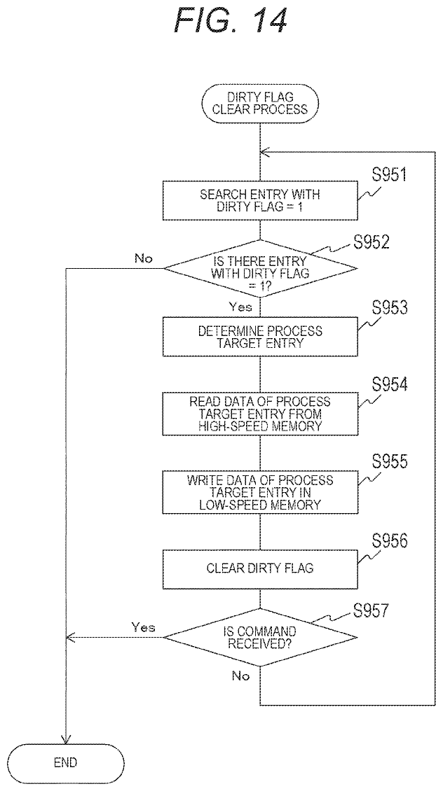

FIG. 14 is a flowchart illustrating an example of a processing procedure of the dirty flag clear process of the cache driver 104 according to a modification of the first embodiment of the present technology.

In an idle state in which no command is received from the software 101, the cache driver 104 searches for an entry whose dirty flag indicates “dirty” (step S951). In a case where there is no entry indicating “dirty” (step S952: No), the dirty flag clear process is terminated.

In a case where there is an entry indicating “dirty” (step S952: Yes), the access frequency management information table 123 is referred to, and the processing target entry in the high-speed memory device 200 is determined by the LRU algorithm for example (step S953). Then, the data of the processing target entry is read from the high-speed memory device 200 (step S954) and written to the low-speed memory device 300 (step S955). Thereafter, the dirty flag of the entry is cleared (step S956). As a result, the dirty flag indicates “clean”.

This dirty flag clear process can be repeated (step S957: No) until the cache driver 104 receives a new command from the software 101 (step S957: Yes).

As described above, according to the modification of the first embodiment of the present technology, in a case where the dirty flag clear process is performed in advance, the processing required in the exporting process during the execution of the write command can be reduced.

### 2. Second Embodiment

According to the first embodiment described above, one entry is managed using one entry usage flag; however, in such a case, data needs to be written from the low-speed memory device 300 to the high-speed memory device 200 all at once and it is also necessary to collectively write back “dirty” data from the high-speed memory device 200 to the low-speed memory device 300. Therefore, even in a case where only a part of the entry is used, it is needed to replace the entire entry, and there is a possibility that useless processing is performed. Therefore, according to a second embodiment, management is performed by dividing one entry into a plurality of sectors. Note that the basic configuration of the information processing system is similar to that of the first embodiment described above, and a detailed description thereof will be omitted.

[Table Configuration]

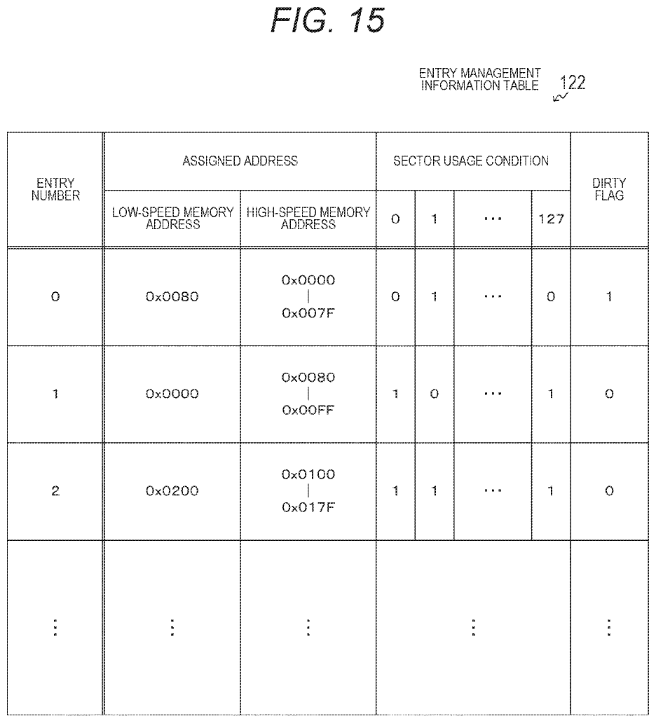

FIG. 15 is a diagram illustrating an example of the contents stored in the entry management information table 122 according to the second embodiment of the present technology.

The entry management information table 122 according to the second embodiment holds “sector usage status” in place of the “entry usage flag” according to the first embodiment. This “sector usage status” indicates whether or not each of the 128 sectors corresponding to the “high-speed memory address” of the high-speed memory device 200 is in use. As a result, it is possible to manage the usage in units of sectors (512 B), not in units of entries (64 KB) as in the first embodiment described above. Note that the “sector usage status” is an example of usage condition information described in the claims.

According to the second embodiment, for the assignment of the high-speed memory device 200, continuous areas are collectively assigned to one entry. For example, a 64 KB entry is assigned to the high-speed memory device 200, but the data may be transferred to the high-speed memory device 200 when it becomes necessary for every 512 B sector. Therefore, unnecessary data transfer can be reduced.

[Operation]

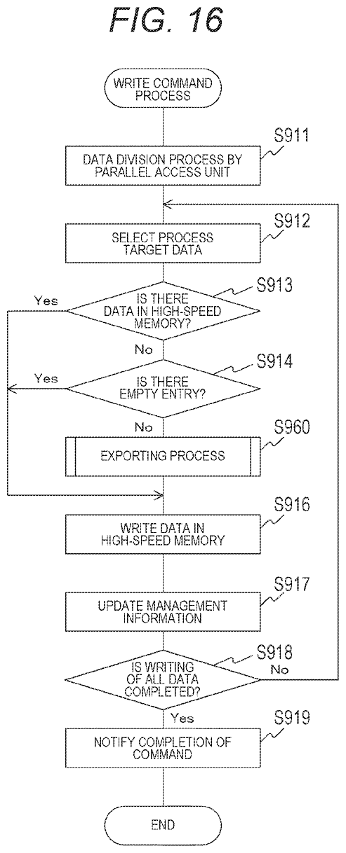

FIG. 16 is a flowchart illustrating an example of a processing procedure of a write command process of the cache driver 104 according to the second embodiment of the present technology.

The write command process according to the second embodiment is basically similar to that of the first embodiment described above. However, the difference is that the process of copying the data of the low-speed memory device 300 (step S915) is not required regarding the empty entry of the high-speed memory device 200. As will be described later, lacking data is added later.

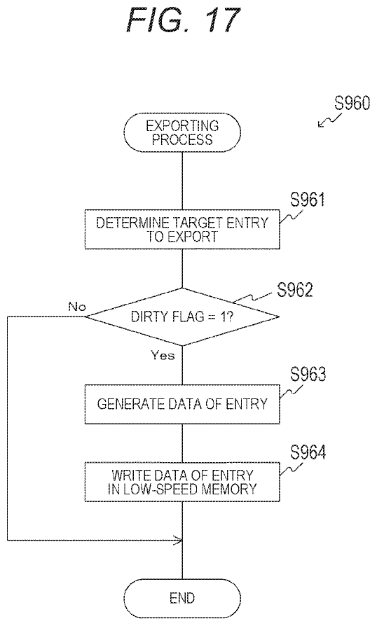

FIG. 17 is a flowchart illustrating an example of a processing procedure of the entry exporting process (step S960) of the cache driver 104 according to the second embodiment of the present technology.

The entry exporting process according to the second embodiment is basically similar to that in the first embodiment. However, the difference is, in a case where the “dirty flag” of the entry to be exported indicates “dirty” (step S962: Yes), the cache driver 104 generates entry data (step S963). In other words, the cache driver 104 reads data from the low-speed memory device 300 according to the “sector usage status” and merges the read data with the data of the high-speed memory device 200, thereby generating data for the entire entry.

In a case where the status indicated by the “sector usage status” of the exporting target entry is one continuous sector of less than 128 sectors, data may be written to the low-speed memory device 300 by executing a single write command without generating data for the entire entry. In this case, the process corresponding to the entry data generation is executed inside the low-speed memory device 300, the process of reading out through the low-speed memory interface 140 is reduced, and the processing time can be shortened.

Note that, as in the modification of the first embodiment described above, the cache driver 104 may perform the dirty flag clear process in an idle state in which no command is received from the software 101.

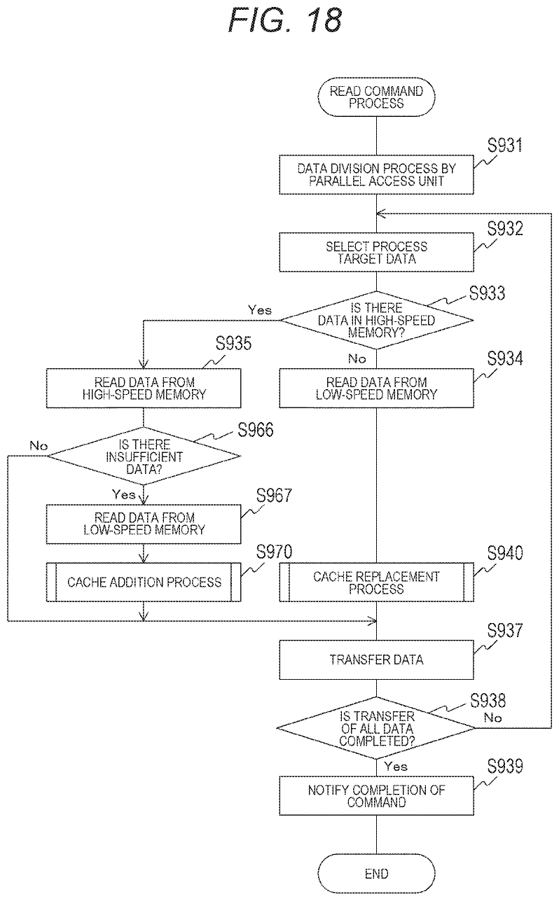

FIG. 18 is a flowchart illustrating an example of a processing procedure of the read command processing of the cache driver 104 according to the second embodiment of the present technology.

The read command process according to the second embodiment is basically similar to that of the first embodiment described above. However, the difference is, in a case where data is read from the high-speed memory device 200 (step S935), data is added if there is insufficient data. In other words, in a case where it is necessary to read a sector whose “sector usage status” is “unused” (“0”, for example) (step S966: Yes), the data is read from the low-speed memory device 300 (step S967) and transfers the data to the software 101. Then, additionally, a process of adding the data also to the high-speed memory device 200 is performed (step S970). With this configuration, data can be copied from the low-speed memory device 300 to the high-speed memory device 200 at timing when it becomes necessary.

Note that the cache replacement process is similar to that in the first embodiment described above and, also according to the second embodiment, the cache replacement process may be performed after the read command process is completed.

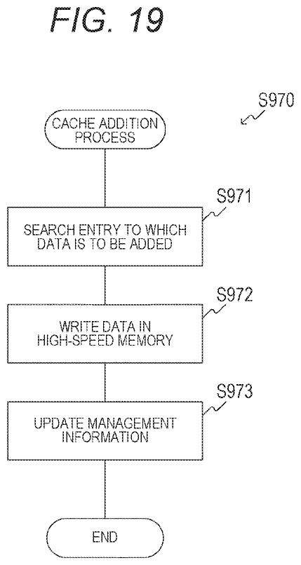

FIG. 19 is a flowchart illustrating an example of a processing procedure of the cache addition process (step S970) of the cache driver 104 according to the first embodiment of the present technology.

The cache driver 104 searches for an entry to which data is added in the high-speed memory device 200 (step S971). Then, the data read in step S967 is written into the high-speed memory device 200 (step S972). Furthermore, the entry management information table 122 is updated (step S973).

Note that this cache addition process may be performed after the read command process is completed.

As described above, according to the second embodiment of the present technology, since the usage is managed in units of sectors in an entry, unnecessary data transfer can be reduced.

### 3. Third Embodiment

According to the second embodiment described above, the “sector usage status” is managed corresponding to continuous sectors of the high-speed memory device 200, however, assignment of the high-speed memory device 200 can be performed arbitrarily. According to the third embodiment, the area of the high-speed memory device 200 is assigned only to the read or written data in the entry. Note that the basic configuration of the information processing system is similar to that of the first embodiment described above, and a detailed description thereof will be omitted.

[Table Configuration]

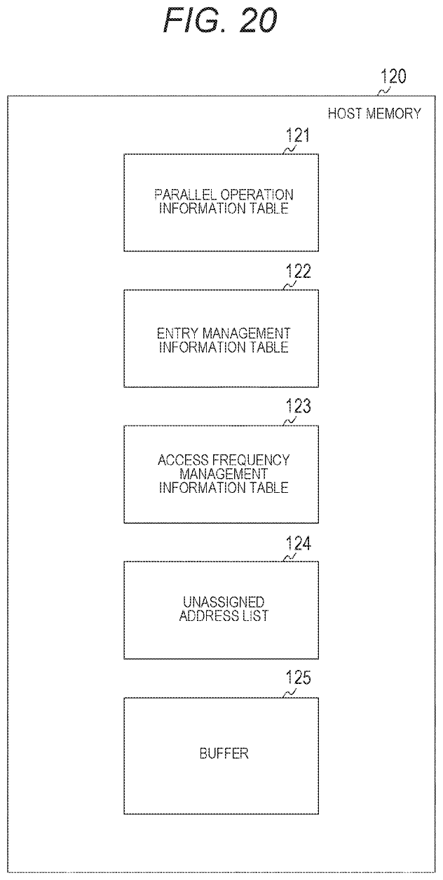

FIG. 20 is a diagram illustrating an example of the storage contents of the host memory 120 according to the third embodiment of the present technology.

According to the third embodiment, an unassigned address list 124 is stored in addition to the information described in the first embodiment described above. The unassigned address list 124 manages an area that is not assigned as a cache entry in the area of the high-speed memory device 200.

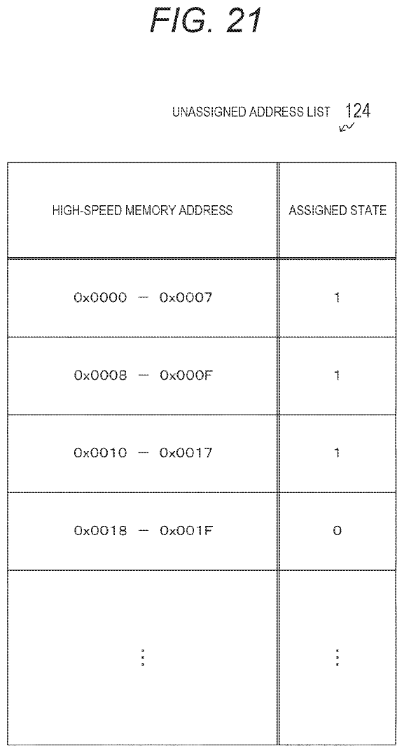

FIG. 21 is a diagram illustrating an example of the stored contents of the unassigned address list 124 according to the third embodiment of the present technology.

The unassigned address list 124 holds an “assigned state” indicating whether or not the area is assigned as a cache entry corresponding to the “high-speed memory address” of the high-speed memory device 200. The cache driver 104 can determine whether or not the area of the high-speed memory device 200 is assigned as a cache entry by referring to the unassigned address list 124.

In a case of assigning the high-speed memory device 200, the address space of the high-speed memory device 200 is divided in accordance with the size (4 KB) that maximizes the throughput of the high-speed memory device 200 and the address alignment.

The assigned state as a cache is managed for each divided address space. In other words, the unassigned address list 124 is managed in parallel access units (4 KB) by 4 KB alignment.

Note that, in this example, continuous addresses aligned in 4 KB are described, but the head address may be used as a representative value.

Furthermore, in place of the address of the high-speed memory device 200, as an index, the number is applied in the order of “0” to the head address (0x0000) with the smallest value and “1” to the head address (0x0008) with the next smallest value to manage. In this case, in order to obtain the head address from the index, it is possible to calculate by “index number×alignment”.

The “assigned state” indicates an assigned state for each divided address space. In a case where the “assigned state” is “1” for example, it indicates a state of being assigned as a cache, and in a case of “0”, it indicates a state of being not assigned as a cache. In a case where assigning as a cache is needed, the cache driver 104 refers to the unassigned address list 124 from the top, searches for an address space where the “assigned state” indicates “0,” and assigns the corresponding address space.

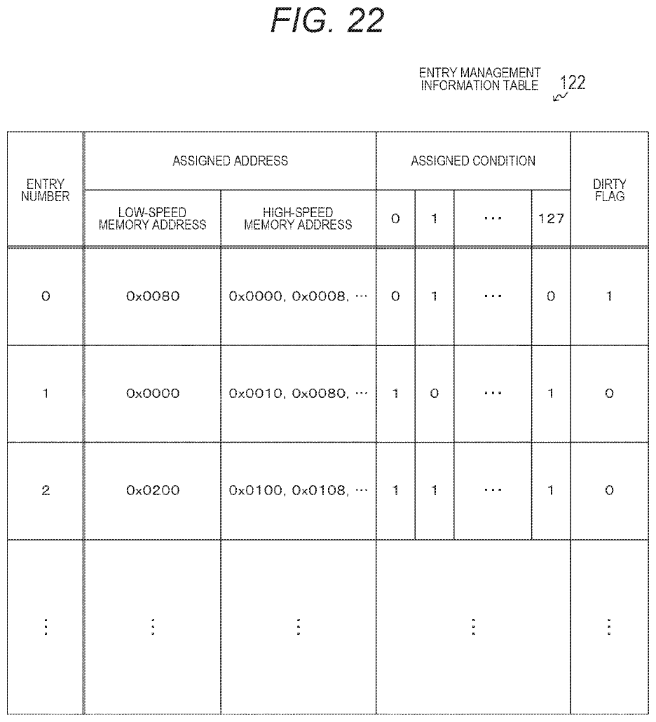

FIG. 22 is a diagram illustrating an example of the storage contents of the entry management information table 122 according to the third embodiment of the present technology.

The entry management information table 122 according to the third embodiment individually designates “high-speed memory addresses” and holds “assigned condition” in place of the “entry usage flag” in the first embodiment described above. The “assigned condition” indicates which area of the low-speed memory device 300 the area assigned to the high-speed memory device 200 corresponds to.

By combining the “high-speed memory address” and the “assigned condition”, it is possible to recognize the assigned condition in units of sectors, which is assigned or unassigned and the assigned address arrangement. Note that the assigned condition is an example of usage condition information described in the claims.

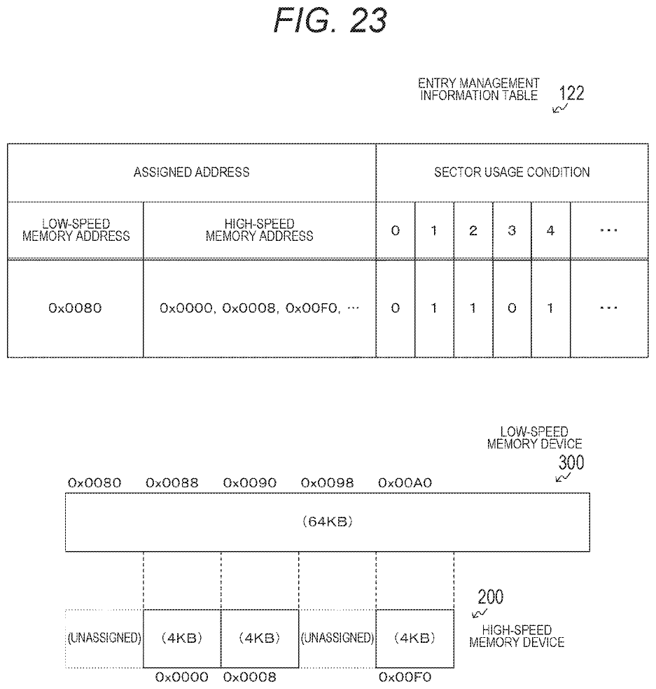

FIG. 23 is a diagram illustrating a specific example of an area assigned condition of the high-speed memory device 200 according to the third embodiment of the present technology.

In this example, the parallel access unit 4 KB of the high-speed memory device 200 is individually assigned to the parallel access unit 64 KB of the low-speed memory device 300. In other words, in the area from “0x0080” of the low-speed memory device 300, no cache entry is assigned to the first 4 KB area. An area “0x0000” of the high-speed memory device 200 is assigned to a second 4 KB area. An area “0x0008” of the high-speed memory device 200 is assigned to a third 4 KB area. No cache entry is assigned to a fourth 4 KB area. An area “0x00F0” of the high-speed memory device 200 is assigned to a fifth 4 KB area.

As described above, by referring to the entry management information table 122 according to the third embodiment, the area of the high-speed memory device 200 assigned to the low-speed memory device 300 can be recognized.

[Operation]

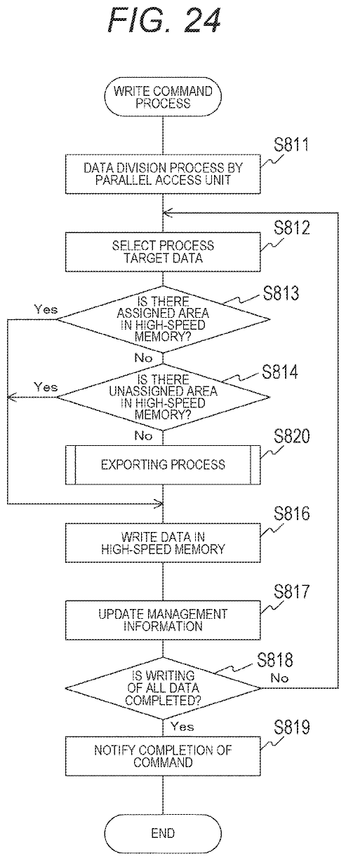

FIG. 24 is a flowchart illustrating an example of a processing procedure of a write command process of the cache driver 104 according to the third embodiment of the present technology.

The write command process according to the third embodiment is basically similar to that in the second embodiment described above. However, as described below, the difference from the second embodiment is that the assigned condition to the high-speed memory device 200 is determined rather than the sector usage condition in the high-speed memory device 200.

The cache driver 104 selects data to be processed (step S812), and determines whether or not an area for writing all pieces of the data has already been assigned to the high-speed memory device 200 (step S813). In a case of being not assigned yet (step S813: No), it is determined whether or not there is an unassigned area for writing all pieces of the data to be processed, together with the assigned area, in the area of the high-speed memory device 200 (Step S814). In a case where there is no such unassigned area (step S814: No), the entry exporting process of the high-speed memory device 200 is executed (step S820). Note that the contents of the entry exporting process (step S820) will be described later.

Thereafter, data is written into the high-speed memory device 200 (step S816). At this time, data to be processed is written in the assigned area or the unassigned area. Then, regarding this writing, the entry management information table 122 is updated (step S817).

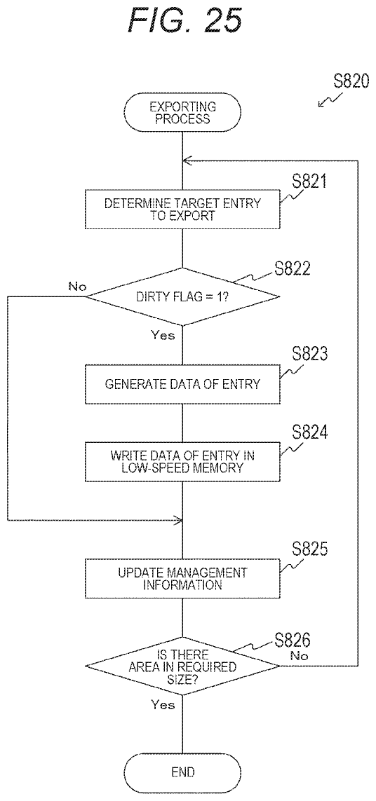

FIG. 25 is a flowchart illustrating an example of a processing procedure of the entry exporting process (step S820) of the cache driver 104 according to the third embodiment of the present technology.

The cache driver 104 refers to the access frequency management information table 123, and determines an exporting target entry in the high-speed memory device 200 by the LRU algorithm, for example (step S821).

In a case where the “dirty flag” of the entry to be exported indicates “dirty” (step S822: Yes), the data of the entry is read from the high-speed memory device 200 (step S823) and written to the low-speed memory device 300 (step S824). As a result, the data in the low-speed memory device 300 is updated. On the other hand, in a case where the “dirty flag” of the entry to be exported indicates “clean” (step S822: No), since the data of the low-speed memory device 300 of the entry matches the high-speed memory device 200, the data is not needed to be written back to the low-speed memory device 300. Thereafter, the entry management information table 122 is updated (step S825).

It is determined whether or not the size of the area of the high-speed memory device 200 exported (released) in this manner is equal to or larger than the size to write new data (step S826). In a case where the size is not large enough (step S826: No), the processing after step S821 is repeated. In a case where the required size is satisfied (step S826: Yes), this exporting process is terminated.

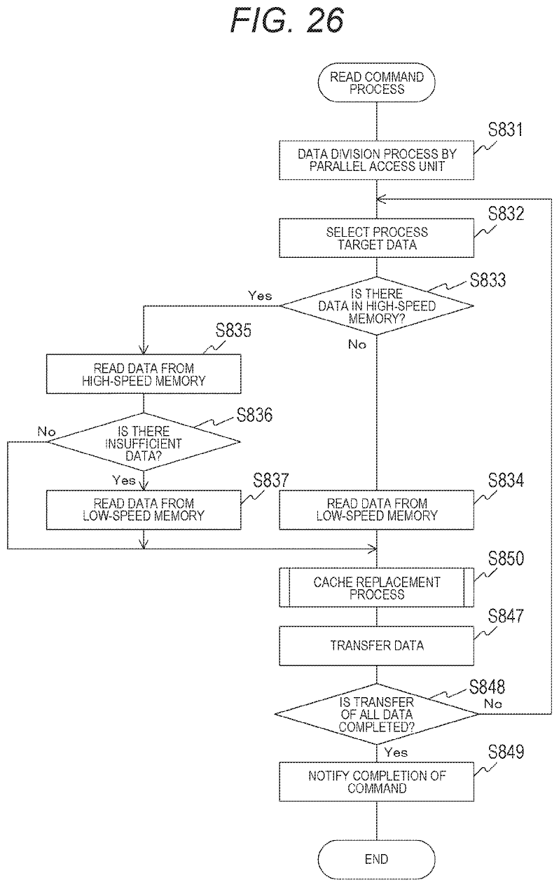

FIG. 26 is a flowchart illustrating an example of a processing procedure of a read command process of the cache driver 104 according to the third embodiment of the present technology.

The read command process according to the third embodiment is basically similar to that of the second embodiment described above. However, as described below, the difference from the second embodiment is that, in a case where data is insufficient, the cache is replaced instead of adding data in units of sectors as in the second embodiment.

In a case where the data to be processed is stored in the high-speed memory device 200 (step S833: Yes), the cache driver 104 reads the data from the high-speed memory device 200 (step S835). At this time, in a case where there is insufficient data (step S836: Yes), the insufficient data is read from the low-speed memory device 300 (step S837), and returned to the software 101 when necessary data is prepared. Thereafter, a cache replacement process is performed (step S850).

On the other hand, in a case where the data to be processed is not stored in the high-speed memory device 200 (step S833: No), all pieces of the data to be processed is read from the low-speed memory device 300 (step S834), and the read data is returned to the software 101. Even in this case, the cache replacement processing is performed (step S850).

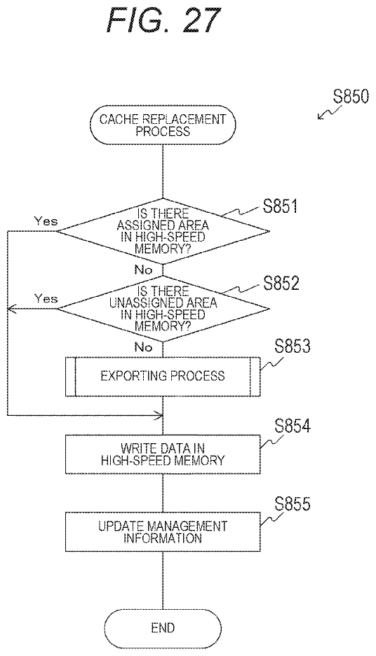

FIG. 27 is a flowchart illustrating an example of a processing procedure of the cache replacement process (step S850) of the cache driver 104 according to the third embodiment of the present technology.

In a case where there is no assigned area in the high-speed memory device 200 (step S851: No), the cache driver 104 determines whether or not there is an unassigned area that can be used in the high-speed memory device 200 (step S852). In a case where there is no unassigned area (step S852: No), an entry exporting process of the high-speed memory device 200 is executed (step S853). Note that the contents of the entry exporting process (step S853) are similar to the entry exporting process (step S820) described above, and a detailed description thereof will be omitted.

Thereafter, data is written to the high-speed memory device 200 (step S854). Furthermore, the entry management information table 122 is updated (step S955).

Thus, according to the third embodiment of the present technology, by managing the assigned condition of the high-speed memory device 200 in the entry management information table 122, the assignment of the high-speed memory device 200 can be performed in an arbitrary arrangement.

### 4. Fourth Embodiment

In the above described embodiments, it has been assumed that the parallel access units of the high-speed memory device 200 and the low-speed memory device 300 are known. According to the fourth embodiment, in a case where at least one of the parallel access units of the high-speed memory device 200 or the low-speed memory device 300 is an unknown value, a method for measuring the value. Note that the assumed information processing system is similar to that of the above described embodiments, and thus detailed description thereof is omitted.

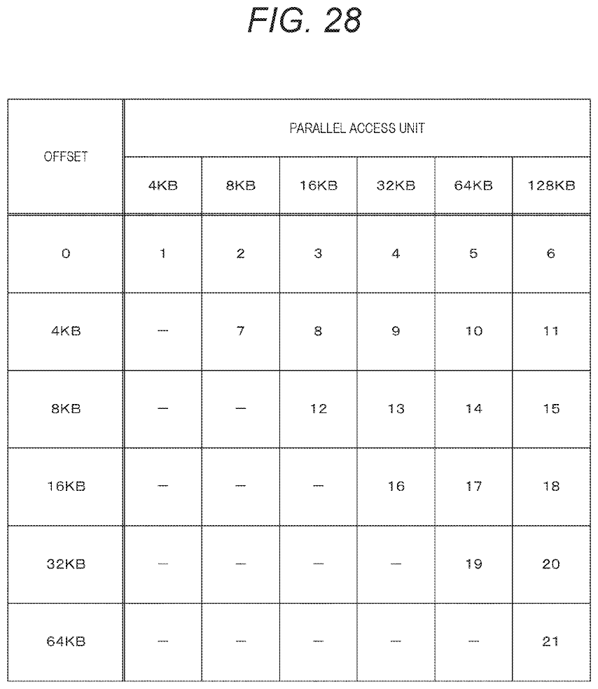

FIG. 28 illustrates an example of a combination of an offset to be measured and a parallel access unit according to the fourth embodiment of the present technology.

According to the fourth embodiment, a plurality of combinations of offsets and parallel access units are set in advance, the performance of each combination is measured in order, and the combination with the highest throughput is employed. In a case where there is a plurality of combinations having the same calculated throughput value, the respective smallest values in the offset values and parallel access units are selected. In this example, 6 types of 4 KB, 8 KB, 16 KB, 32 KB, 64 KB, and 128 KB are assumed as parallel access units, and 6 types of 0, 4 KB, 8 KB, 16 KB, 32 KB, and 64 KB are assumed as alignment offsets. Among these, numbers 1 to 21 are selected in order.

In a case of measuring the performance, for example, a write command is executed, and the response time for one command or the number of commands executed during a unit time is measured. At this time, the transfer data size of the write command is set as the selected parallel access unit. Furthermore, “offset+parallel access unit” is designated as a start address.

In a case where the response time for one command is measured, the throughput (bytes/second) is calculated from “transfer size/response time”. In a case where the number of commands executed during the unit time is measured, “the number of commands×transfer data size” is calculated to calculate the throughput.

[Operation]

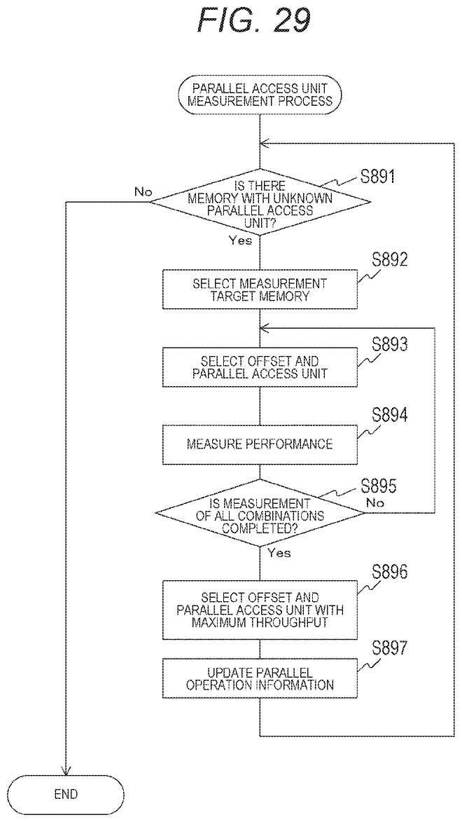

FIG. 29 is a flowchart illustrating an example of a processing procedure of parallel access unit measurement processing of the cache driver 104 according to the fourth embodiment of the present technology. In a case where there is an unknown value for the parallel access unit in the memory of the information processing system (that is, the low-speed memory device 300 and the high-speed memory device 200 in this example) (step S891: Yes), the cache driver 104 measures the parallel access unit with the following procedure.

The cache driver 104 selects a memory to be measured (step S892). Then, as selecting a combination of the offset and the parallel access unit one by one (step S893), the performance by the combination is measured (step S894). The cache driver 104 executes performance measurement using an unillustrated timer. This measurement is repeated for all combinations of preset offsets and parallel access units (step S895: No).

In a case where the measurement is completed for all the combinations (step S895: Yes), the combination of the offset and the parallel access unit having the highest throughput is selected (step S896). In accordance with the result, the parallel operation information table 121 is updated (step S897).

Finally, in a case where there are no parallel access units with unknown values (step S891: No), the parallel access unit measurement process ends.

In this manner, according to the fourth embodiment of the present technology, even in a case of a memory in which the parallel access unit is an unknown, the parallel access unit can be obtained by measurement and set in the parallel operation information table 121.

### 5. Fifth Embodiment

In the above described embodiments, the configuration in which the memory controller is arranged in each of the high-speed memory device 200 and the low-speed memory device 300 is assumed. Therefore, it is necessary to distribute access to the high-speed memory device 200 or the low-speed memory device 300 by the cache driver 104 of the host computer 100. On the other hand, according to the fifth embodiment, the memory controllers are integrated into one so that the high-speed memory and the low-speed memory can be properly used by the host computer 100 with no particular attention.

[Configuration of Information Processing System]

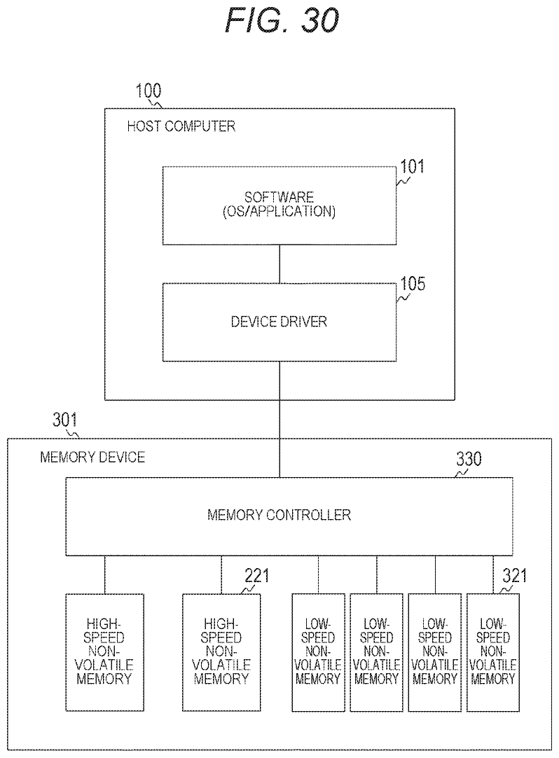

FIG. 30 is a diagram illustrating a configuration example of an information processing system according to a fifth embodiment of the present technology.

This information processing system includes a host computer 100 and a memory device 301. Unlike the above described first to fourth embodiments, the memory device 301 includes both a high-speed non-volatile memory 221 and a low-speed non-volatile memory 321 and is connected to a memory controller 330, respectively. The memory controller 330 determines whether to access the high-speed non-volatile memory 221 or the low-speed non-volatile memory 321.

Since the host computer 100 does not need to pay attention to whether to access the high-speed non-volatile memory 221 or the low-speed non-volatile memory 321, a cache driver is unnecessary, unlike the first to fourth embodiments described above. Instead, the host computer 100 includes a device driver 105 for accessing the memory device 301 from the software 101.

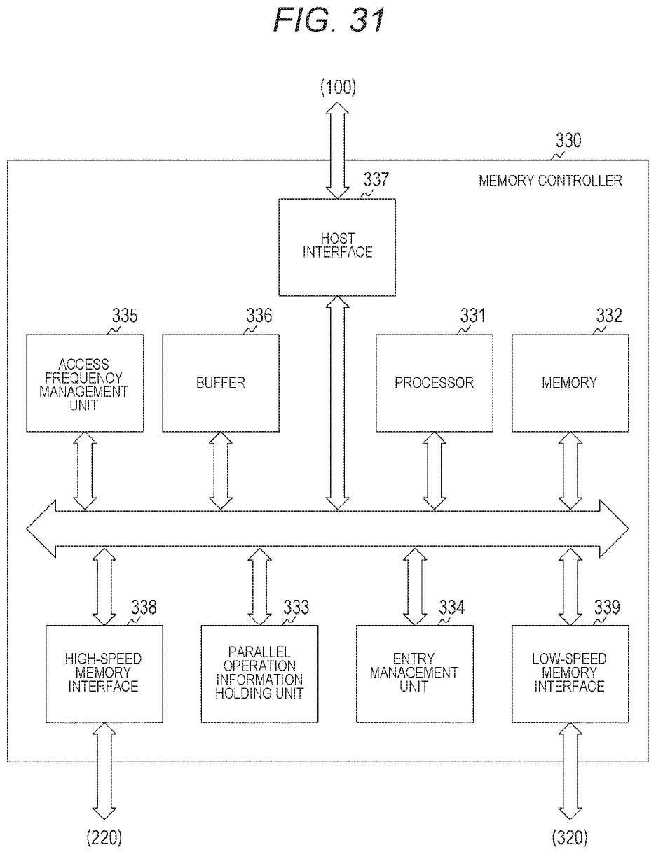

FIG. 31 is a diagram illustrating a configuration example of a memory controller 330 according to the fifth embodiment of the present technology.

The memory controller 330 performs similar processing as the cache driver 104 in the first to fourth embodiments described above. Therefore, the memory controller 330 includes a processor 331, a memory 332, a parallel operation information holding unit 333, an entry management unit 334, an access frequency management unit 335, and a buffer 336. Furthermore, a host interface 337, a high-speed memory interface 338, and a low-speed memory interface 339 are provided as interfaces with the outside. Note that the memory controller 330 is an example of an access control unit described in the claims.

The processor 331 is a processing device that performs processing for operating the memory controller 330. The memory 332 is a memory for storing data and programs necessary for the operation of the processor 331.

The parallel operation information holding unit 333 holds a parallel operation information table 121 that holds information for performing a parallel operation on the high-speed non-volatile memory 221 and the low-speed non-volatile memory 321. The entry management unit 334 manages the entry management information table 122 for managing each entry in a case of using the high-speed non-volatile memory 221 as a cache memory. The access frequency management unit 335 manages the access frequency management information table 123 that manages the access frequency for each entry in a case of using the high-speed non-volatile memory 221 as a cache memory. The buffer 336 is a buffer used in a case where data is exchanged between the high-speed memory device 200 and the low-speed memory device 300.

The host interface 337 is an interface for communicating with the host computer 100. The high-speed memory interface 338 is an interface for communicating with the high-speed non-volatile memory 221. The low-speed memory interface 339 is an interface for communicating with the low-speed non-volatile memory 321.

In such a configuration, the memory controller 330 performs write access, read access, and the like for the high-speed non-volatile memory 221 and the low-speed non-volatile memory 321. Since the contents of the control are similar to those of the cache driver 104 in the first to fourth embodiments described above, detailed description thereof is omitted.

As described above, according to the fifth embodiment of the present technology, since it is determined in the memory device 301 which memory should be accessed, the host computer 100 can use the memory with no particular attention.

It should be noted that the above-described embodiment represents an example for embodying the present technology, and matters in the embodiment and invention specifying matters in the claims have correspondence relationships, respectively. Likewise, the invention specifying matters in the claims and the matters in the embodiment of the present technology denoted by the same names have correspondence relationships. However, the present technology is not limited to the embodiment and can be embodied by subjecting the embodiment to various modifications without departing from the gist thereof.

Furthermore, the processing procedure described in the above embodiment may be regarded as a method having these series of procedures, as a program for causing a computer to execute these series of procedures, or as a recording medium for storing the program. As this recording medium, for example, a Compact Disc (CD), a MiniDisc (MD), a Digital Versatile Disc (DVD), a memory card, a Blu-ray (registered trademark) Disc (Blu-ray Disc), and the like can be used.

Note that, the effects described in this specification are examples and should not be limited and there may be other effects.

Furthermore, the present technology may have following configurations.

(1) A memory access device including:

a management information storage unit that stores management information as associating each corresponding management unit of first and second memory devices, respectively, the memory devices including a plurality of parallel accessible memories and having different parallel accessible data sizes and different access speeds; and

an access control unit that accesses one of the first and second memory devices on the basis of the management information.

(2) The memory access device according to above (1), in which

the second memory device has a faster access speed and a smaller parallel accessible data size compared to the first memory device, and

the management information storage unit stores the management information with the parallel accessible data sizes of the first and second memory devices in respective management units.

(3) The memory access device according to above (2), in which

the management information storage unit stores the management information as associating one predetermined management unit of the first memory device with a plurality of corresponding management units of the second memory device.

(4) The memory access device according to above (3), in which

the management information storage unit stores usage condition information that indicates usage condition of an entire of the plurality of management units of the second memory device, corresponding to the one predetermined management unit of the first memory device.

(5) The memory access device according to above (3), in which

the management information storage unit stores usage condition information that indicates usage condition of each of the plurality of management units of the second memory device, corresponding to the one predetermined management unit of the first memory device.

(6) The memory access device according to above (5), in which

the usage condition information indicates the usage condition of each of the plurality of management units of the second memory device assigned corresponding to the one predetermined management unit of the first memory device in order of assigned addresses.

(7) The memory access device according to above (5), in which

the usage condition information indicates an assigned condition of each of the plurality of management units of the second memory device, corresponding to the one predetermined management unit of the first memory device.

(8) The memory access device according to any one of above (3) and (5) to (7), in which

the management information storage unit stores, as assignment information, whether or not being assigned corresponding to the management unit of the first memory device, for each of the plurality of management units of the second memory device.

(9) The memory access device according to any one of above (3) to (8), in which

the management information storage unit stores inconsistency information that indicates whether or not there is inconsistency with the first memory device, in any one of the plurality of management units of the second memory device, corresponding to the one predetermined management unit of the first memory device.

(10) The memory access device according to above (9), in which, in an idle state, a process for writing, to the corresponding first memory device, data of the second memory device in which the inconsistency information indicates inconsistency with the first memory device is executed.

(11) The memory access device according to any one of above (3) to (10), in which

the one predetermined management unit of the first memory device is assigned to each area where a write command is executed with a maximum throughput of the first memory device.

(12) A memory system including:

first and second memory devices that respectively include a plurality of parallel accessible memories and have different parallel accessible data sizes and different access speeds;

a management information storage unit that stores management information as associating each corresponding management unit of the first and second memory devices; and

an access control unit that accesses one of the first and second memory devices on the basis of the management information.

(13) The memory system according to above (12), in which

the first and second memory devices are non-volatile memories.

(14) An information processing system including:

first and second memory devices that respectively include a plurality of parallel accessible memories and have different parallel accessible data sizes and different access speeds;

a host computer that issues an access command to the first memory device; and

an access control unit that includes a management information storage unit and accesses one of the first and second memory devices on the basis of the management information, the management information storage unit storing management information as associating each corresponding management unit of the first and second memory devices.

(15) The information processing system according to above (14), in which

the access control unit is a device driver in the host computer.

(16) The information processing system according to above (14), in which

the access control unit is a memory controller in the first and second memory devices.

### REFERENCE SIGNS LIST

100 Host computer
101 Software
104 Cache driver
105 Device driver
110 Processor
120 Host memory
121 Parallel operation information table
122 Entry management information table
123 Access frequency management information table
124 Unassigned address list
125 Buffer
130 High-speed memory interface
140 Low-speed memory interface
180 Bus
200 High-speed memory device
210 Memory controller
220 Non-volatile memory
221 High-speed non-volatile memory
300 Low-speed memory device
301 Memory device
310 Memory controller
320 Non-volatile memory
321 Low-speed non-volatile memory
330 Memory controller
331 Processor
332 Memory
333 Parallel operation information holding unit
334 Entry management unit
335 Access frequency management unit
336 Buffer
337 Host interface
338 High-speed memory interface
339 Low-speed memory interface
400 Memory system

1. A memory access device comprising:
a management information storage unit that stores management information as associating each corresponding management unit of first and second memory devices respectively, the memory devices including a plurality of parallel accessible memories and having different parallel accessible data sizes and different access speeds; and
an access control unit that accesses one of the first and second memory devices on a basis of the management information.

2. The memory access device according to claim 1, wherein
the second memory device has a faster access speed and a smaller parallel accessible data size compared to the first memory device, and
the management information storage unit stores the management information with the parallel accessible data sizes of the first and second memory devices in respective management units.

3. The memory access device according to claim 2, wherein
the management information storage unit stores the management information as associating one predetermined management unit of the first memory device with a plurality of corresponding management units of the second memory device.

4. The memory access device according to claim 3, wherein
the management information storage unit stores usage condition information that indicates usage condition of an entire of the plurality of management units of the second memory device, corresponding to the one predetermined management unit of the first memory device.

5. The memory access device according to claim 3, wherein
the management information storage unit stores usage condition information that indicates usage condition of each of the plurality of management units of the second memory device, corresponding to the one predetermined management unit of the first memory device.

6. The memory access device according to claim 5, wherein
the usage condition information indicates the usage condition of each of the plurality of management units of the second memory device assigned corresponding to the one predetermined management unit of the first memory device in order of assigned addresses.

7. The memory access device according to claim 5, wherein
the usage condition information indicates an assigned condition of each of the plurality of management units of the second memory device, corresponding to the one predetermined management unit of the first memory device.

8. The memory access device according to claim 3, wherein
the management information storage unit stores, as assignment information, whether or not being assigned corresponding to the management unit of the first memory device, for each of the plurality of management units of the second memory device.

9. The memory access device according to claim 3, wherein
the management information storage unit stores inconsistency information that indicates whether or not there is inconsistency with the first memory device, in any one of the plurality of management units of the second memory device, corresponding to the one predetermined management unit of the first memory device.

10. The memory access device according to claim 9, wherein, in an idle state, a process for writing, to the corresponding first memory device, data of the second memory device in which the inconsistency information indicates inconsistency with the first memory device is executed.

11. The memory access device according to claim 3, wherein
the one predetermined management unit of the first memory device is assigned to each area where a write command is executed with a maximum throughput of the first memory device.

12. A memory system comprising:
first and second memory devices that respectively include a plurality of parallel accessible memories and have different parallel accessible data sizes and different access speeds;
a management information storage unit that stores management information as associating each corresponding management unit of the first and second memory devices; and
an access control unit that accesses one of the first and second memory devices on a basis of the management information.

13. The memory system according to claim 12, wherein
the first and second memory devices are non-volatile memories.

14. An information processing system comprising:
first and second memory devices that respectively include a plurality of parallel accessible memories and have different parallel accessible data sizes and different access speeds;
a host computer that issues an access command to the first memory device; and
an access control unit that includes a management information storage unit and accesses one of the first and second memory devices on a basis of the management information, the management information storage unit storing management information as associating each corresponding management unit of the first and second memory devices.

15. The information processing system according to claim 14, wherein
the access control unit is a device driver in the host computer.

16. The information processing system according to claim 14, wherein
the access control unit is a memory controller in the first and second memory devices.
